(19) United States
(12) Patent Application Publication
(10) Pub. No.: US 2024/0289418 A1
(43) Pub. Date: Aug. 29, 2024

(54) SIMULATOR AND METHOD FOR OPERATING A SIMULATOR

(71) Applicant: dSPACE GmbH, Paderborn (DE)

(72) Inventors: Axel KIFFE, Paderborn (DE); Thorben HOFFSTADT, Paderborn (DE)

(21) Appl. No.: 18/572,221

(22) PCT Filed: Jul. 1, 2022
(86) PCT No.: PCT/EP2022/068232

§ 371 Date: Dec. 20, 2023

(30) Foreign Application Priority Data
Jul. 2, 2021 (DE) 10 2021 117 141.5

(51) Int. Cl. G06F 17/16

(52) U.S. Cl. CPC G06F 17/16

(57) ABSTRACT

A simulator includes an arithmetic unit configured to simulate a technical system. The simulator is configured to determine an output vector for outputting an output signal of the simulator on the basis of an input vector using matrix-vector multiplication. A matrix represents the technical system. The arithmetic unit has at least one multiplier and at least one adder for the matrix-vector multiplication. The at least one multiplier and the at least one adder are each configured for a time-division multiplexing function for performing their respective tasks. A scheduler is provided, which is configured to assign an output value of the at least one multiplier to the at least one adder.

### CROSS-REFERENCE TO PRIOR APPLICATIONS

This application is a U.S. National Phase application under 35 U.S.C. § 371 of International Application No. PCT/EP2022/068232, filed on Jul. 1, 2022, and claims benefit to German Patent Application No. DE 10 2021 117 141.5, filed on Jul. 2, 2021. The International Application was published in German on Jan. 5, 2023 as WO 2023/275348 A1 under PCT Article 21(2).

### TECHNICAL FIELD

The application relates to a simulator comprising an arithmetic unit, and to a method for operating a simulator.

Embodiments of the application achieve better utilization of available resources of the simulator for calculation purposes, so as to obtain a balance between a latency in the simulator and the required hardware resources.

### SUMMARY

In an exemplary embodiment, the present invention provides a simulator. The simulator includes an arithmetic unit configured to simulate a technical system. The simulator is configured to determine an output vector for outputting an output signal of the simulator on the basis of an input vector using matrix-vector multiplication. A matrix represents the technical system. The arithmetic unit has at least one multiplier and at least one adder for the matrix-vector multiplication. The at least one multiplier and the at least one adder are each configured for a time-division multiplexing function for performing their respective tasks. A scheduler is provided, which is configured to assign an output value of the at least one multiplier to the at least one adder.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows the connection of a simulator to an apparatus that is to be tested;

FIG. 2 schematically shows a hardware design of the simulator;

FIG. 3 is a block diagram for illustrating a mode of operation of the simulator and a method:

FIG. 4 is a time operational sequence chart of matrix-vector multiplication; and

FIG. 5 shows examples of so-called latencies and numbers of multipliers and adders that cause latencies.

In the drawings, the same reference signs are used for the same or similar elements.

### DETAILED DESCRIPTION

An advantage of a simulator comprising an arithmetic unit and of a method for operating a simulator comprising an arithmetic unit of the present application is that improved utilization of available resources for calculation purposes is achieved by parallelizing computing tasks of at least one multiplier and at least one adder.

Therefore, a simulator comprising an arithmetic unit is provided, wherein the simulator simulates a technical system and, in the process, determines an output vector for outputting an output signal of the simulator on the basis of an input vector using matrix-vector multiplication. The matrix represents the technical system, wherein the arithmetic unit has at least one multiplier and at least one adder for the matrix-vector multiplication. The at least one multiplier and the at least one adder are each configured for a time-division multiplexing function for performing their respective tasks. In this case, a scheduler is provided and assigns an output value of the at least one multiplier to the at least one adder. Moreover, the scheduler can assign input values of an envisaged multiplication to the at least one multiplier. Accordingly, the method is designed for operating the simulator comprising an arithmetic unit.

In the present case, a simulator may be understood as an apparatus that is suitable for checking in particular a device, for example a controller, in relation to its proper functioning and also, where applicable, its endurance limit. In other words, the simulator is connected accordingly to the device that is to be tested in order to forward to the device output values in the form of an output signal on the basis of corresponding input values in the form of an input signal by way of the simulation of the technical system, so that the device can then functionally respond thereto. The output values of the device are picked up by the simulator as its input values and processed by the simulated technical system. Therefore, a simulator of this kind has interfaces for establishing the relevant connections to the device. These may be wired or wireless. Simulators of this kind are used predominantly in the automotive industry but also in other industries that use technical devices, in particular with software, so that this software can be adequately tested in relation to its proper functioning or the safety of the operational sequence. Simulators of this kind therefore represent an environment for testing said devices. Devices that have software for the purpose of their operation need to be checked in relation to each of their states, in order to verify the correct operational sequence in all potential situations, in particular in safety-critical devices such as vehicles or other machines.

A central element of a simulator of this kind is an arithmetic unit. This arithmetic unit can have one or more computers, for example microprocessors, microcontrollers, or signal processors, or so-called FPGAs. An FPGA, or field-programmable gate array, is an integrated circuit within digital technology in which a logic circuit can be loaded. As can be taken from the name, the corresponding function is loaded onto said FPGA and programmed in advance. The arithmetic unit can have one such FPGA or a plurality thereof and, in combination, also other processors such as microprocessors, microcontrollers, etc.

The technical system according to this application may be understood to mean all potential apparatuses that are simulated as intended by the simulator in order to be connected to another device during a test phase. Using its arithmetic unit, the simulator will then simulate said technical system on the basis of corresponding input values, so as to generate output values on the basis of said input values. In the process, this technical system is represented by a matrix. The input values are recorded in an input vector. Using a so-called matrix-vector multiplication, the response of the technical system to the input values is determined, i.e., the matrix is multiplied by the input vector. For a matrix-vector multiplication, first the matrix coefficients of one row are multiplied by the vector components of the input vector. Adding these products together results in the first component of the output vector. This is then performed row by row in such a way that the output vector is available in its entirety. Therefore, multipliers and adders are required for this matrix-vector multiplication in order to carry it out. These are then set up in the arithmetic unit in this way in accordance with the available hardware.

According to this application, it is now provided that the at least one multiplier and the at least one adder are each configured for a time-division multiplexing function for performing their respective tasks. For accordingly assigning the tasks in a suitable manner, a so-called scheduler is provided according to this application. This scheduler assigns an output value of the at least one multiplier to the at least one adder. A simple assignment of this kind allows the available resources to be suitably utilized for the matrix-vector multiplication. This is achieved by using the available multipliers and adders in parallel.

The at least one multiplier and the at least one adder and also the scheduler can be embodied in software and/or in hardware on the arithmetic unit of the simulator.

Advantageous improvements to the simulator comprising an arithmetic unit and to the method for operating a simulator of this kind are possible as a result of the measures and developments proposed in the dependent claims.

In one embodiment, the technical system can be a power electronics circuit having at least one switch, and the matrix can represent the power electronics circuit. A power electronics circuit transforms electrical energy and in doing so uses in particular switches, in particular semiconductor switches, embodied for example as transistors and/or thyristors and/or diodes. By way of example, the power electronics circuit actuates an electric motor, diagnoses data from the electric motor, and/or is connected to an energy source, for example a battery or a mains power supply, in order to convert this energy accordingly for the electric motor. For example, the power electronics circuit converts alternating current into direct current, or vice versa. There is therefore a converter present. If such power electronics circuits become more complex, i.e., a plurality of switches are used, the simulation of any such power electronics circuit is accordingly complex. Therefore, the subject matter of the application is resource-efficient in that available multipliers and adders are used in parallel at least in part.

In one embodiment example, to implement the time-division multiplexing function, the at least one multiplier and/or the at least one adder can start its next task before the current task, together with the particular result of that current task, is finished. This can achieve a parallelization that allows time to be saved and means there is no longer any need to wait, for example, until the at least one multiplier has finished calculating the result.

In addition, in one embodiment example it can be provided that at least two clock cycles are provided for the performance of each task of the multiplier and/or the adder. In this case, each next task is already started in each case after one clock cycle has elapsed. This leads to the aforementioned parallelization and thus to improved utilization of the available resources. In this way, the parallelization can be improved so that, for example, the addition can start as soon as the at least one multiplier has finished a multiplication in a preceding clock cycle.

In addition, there are embodiments in which the arithmetic unit has a processor or an FPGA as described above.

In one embodiment, the input vector has electrical parameters, which are intended to be applied to the technical system, in particular to the power electronics circuit. In other words, the input vector has, for example, voltage and/or current values that are applied to the technical system in order to operate it.

Furthermore, it can be provided that the scheduler assigns matrix coefficients and vector components for the matrix-vector multiplication to the at least one multiplier and/or to the at least one adder and/or to further hardware and/or to software components of the arithmetic unit. Therefore, the scheduler may be understood as a control instance that organizes the matrix-vector multiplication. A matrix coefficient may be understood as an entry in a matrix: namely, exactly one such matrix coefficient is present at a predetermined column and a predetermined row. As is known, a vector has a plurality of components, and it is these vector components that are being discussed in the present case.

In one embodiment, the scheduler assigns the particular result of each task of the at least one particular multiplier to the at least one particular adder for the performance of a further task, i.e., the addition. Thus, the result of the multiplication of the at least one multiplier is immediately used for the next task, i.e., the addition. This can shorten the execution period of the matrix-vector multiplication.

In one embodiment, the arithmetic unit has a number of multipliers that is dependent on the size of the matrix. According to this application, it has been found that the number of multipliers can be determined in accordance with the size of the matrix in such a way that the ratio of required hardware resources and latency for the matrix-vector multiplication can be set in an advantageous manner. The size of the matrix may be understood as the product of the multiplication of the number of columns and the number of rows. A preferred number of multipliers is half the size of the matrix.

In such a configuration having a number of multipliers equal to half the size of the matrix, the overall latency increases by comparison with a fully parallelized system. However, this arrangement uses only half the hardware resources needed for a fully parallelized configuration. Compared with the large saving in terms of hardware resources, the increase in the latency is minor. Therefore, by taking the latency into account, the matrix-vector multiplication can be designed systematically.

In one embodiment, the simulator reviews the matrix before the matrix-vector multiplication, wherein the carrying out of the task of the at least one multiplier and/or the carrying out of the task of the at least one adder and/or the assignment of the output value by the scheduler is dependent on the result of the review. Thus, specific values of the matrix coefficient can be considered, and the carrying out of the multiplication and/or the carrying out of the addition and/or the assignment to the adder can be dependent on whether the component has assumed a specific value. For the case of multiplication, specific values are in particular the values 1 and/or 0).

At a matrix coefficient value of 0), no multiplication needs to be carried out since the result of a multiplication by 0 is known and is 0. No subsequent addition needs to be carried out either since an addition of 0 does not change the sum. At a matrix coefficient of 0, therefore, the scheduler would not envisage either the multiplication or the addition.

At a matrix coefficient value of 1, a multiplication by the corresponding vector component need not be carried out since a multiplication by 1 does not change the product. The value of the corresponding vector component can thus be forwarded to the subsequent adder by the scheduler without being multiplied beforehand by the matrix coefficient, which has the value 1.

FIG. 1 shows a simulator SIM, which in the present case is connected to a so-called device under test DUT via cables. From the apparatus DUT, the simulator SIM receives an input signal in the form of an input vector v, which the simulator SIM multiplies using a matrix M that represents the technical system, and specifically by way of a matrix-vector multiplication, in order to generate an output vector b, which is then output to the apparatus DUT as an output signal. In this way, the technical system is simulated by the simulator SIM. The apparatus DUT can thus be tested. By way of example, the simulator SIM simulates a power electronics circuit. The apparatus is, for example, a controller that actuates the power electronics circuit such that it can be tested in relation to its functions as a result, on the basis of corresponding specifications of the controller.

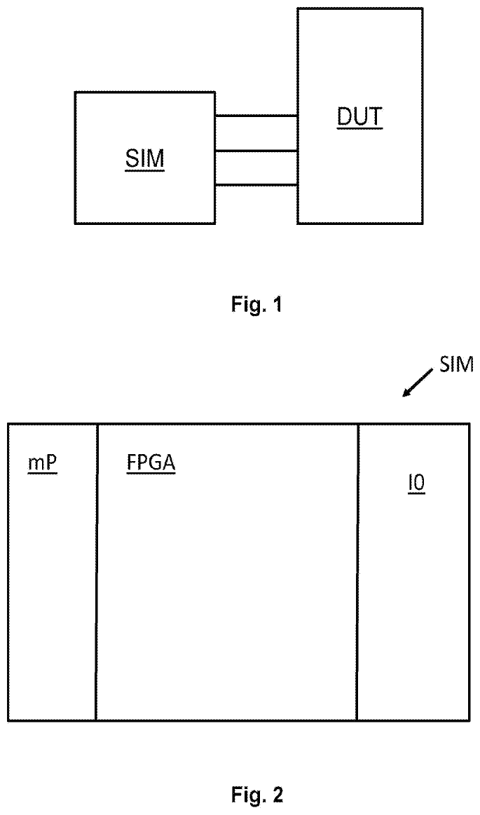

FIG. 2 schematically shows the hardware structure of the simulator SIM. There is a processor mP, which can be a microprocessor or a microcontroller, for example, and a so-called FPGA, a field-programmable gate array, which is programmed in accordance with the structure of, for example, the power electronics circuit. There is also an input/output interface IO, via which the input vector v and, accordingly, also the output vector b are received and output, respectively. The input/output takes place via registers, for example.

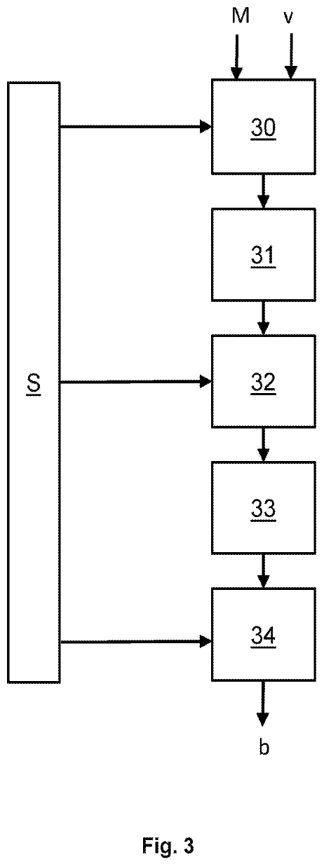

FIG. 3 shows the operational sequence representing a method according to this application or a mode of operation of the simulator in a block diagram. The scheduler S controls this operational sequence of carrying out the steps/blocks 30, 31, 32, 33, 34. For this purpose, a matrix M having matrix coefficients M11, M12, . . . , M21, . . . , Mmn and a vector v having vector components v1, v2, . . . , vn is supplied to a step/block 30. In block 30, corresponding matrix coefficients M11, M12, . . . , M21, . . . , Mmn are each assigned to a corresponding component v1, v2, . . . , vn of the input vector v. In step/block 31, the multiplication among the matrix coefficients M11, M12, . . . , M21, . . . , Mmn by the relevant components of the input vector v is performed by at least one multiplier Mu1, Mu2, Mu3. In step/block 32, the routing takes place, i.e., the results of said multiplications are assigned to the corresponding adders Add1, Add2 by the scheduler S in accordance with a specification. In step/block 33, the multiplication results are then added up. In step/block 34, the corresponding results for the output vector b are stored by the scheduler S in corresponding registers in order to be output via the input/output interface IO.

In this case, the method and the simulator are configured such that individual operations of the steps/blocks 30, 31, 32, 33, 34 are parallelized by multiplexing, and operations of the subsequent steps/blocks can be carried out before other operations of the preceding steps/blocks have ended.

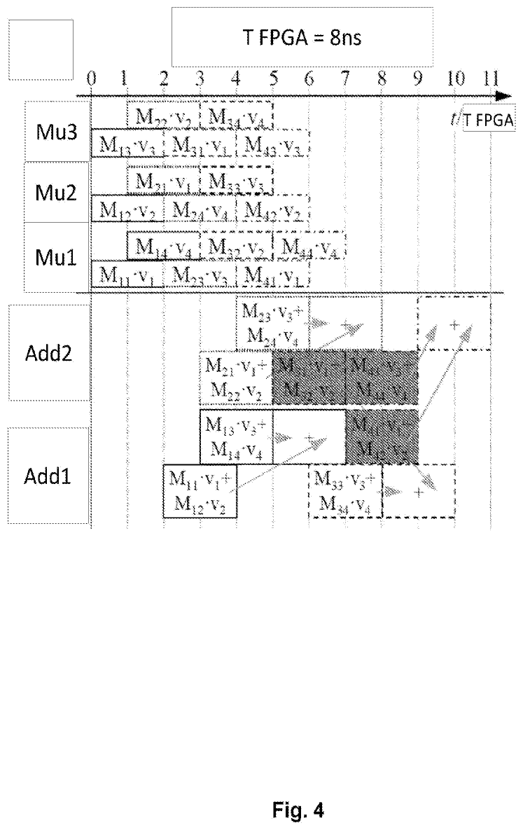

FIG. 4 now shows an example of the operational sequence according to this application in a time chart. The clock time T FPGA of this FPGA is intended to be 8 ns in the present case. By way of example, three multipliers Mu1, Mu2, and Mu3 are provided in this case, as well as two adders Add1 and Add2.

In the present case, two clock cycles T FPGA are provided for each computing operation, i.e., for a multiplication and for an addition. In the first clock cycle T FPGA, the multiplication of the first matrix coefficients and vector components is started, and specifically by way of the multiplication by the multipliers Mu1, Mu2, and Mu3 and, in this regard, the multiplication of the coefficients of the matrix M by components of the vector v M11*V1, M12*V2, and M13*V3. In the second clock cycle T FPGA, however, the next multiplication of the next matrix coefficients and input vector components is already started, and at the same time the multiplications started in the first clock cycle T FPGA are finished. All the multiplications are carried out by the three multipliers Mu1, Mu2, and Mu3 in this staggered manner. When the multiplication results are available, they are assigned to the adders Add1 and Add2 by the scheduler S. In this case too, though, the next addition by each adder is already started in the second clock cycle T FPGA. It is also shown that the interim results of the addition are added together further and further in order to calculate the corresponding output components of the output vector b. In other words, in this adder too, the further addition is always started before the addition started one clock cycle T FPGA prior has ended. Thus, the components of the output vector b are then determined row by row. In other words, in the present case FIG. 4 shows the calculation of a component of the output vector b.

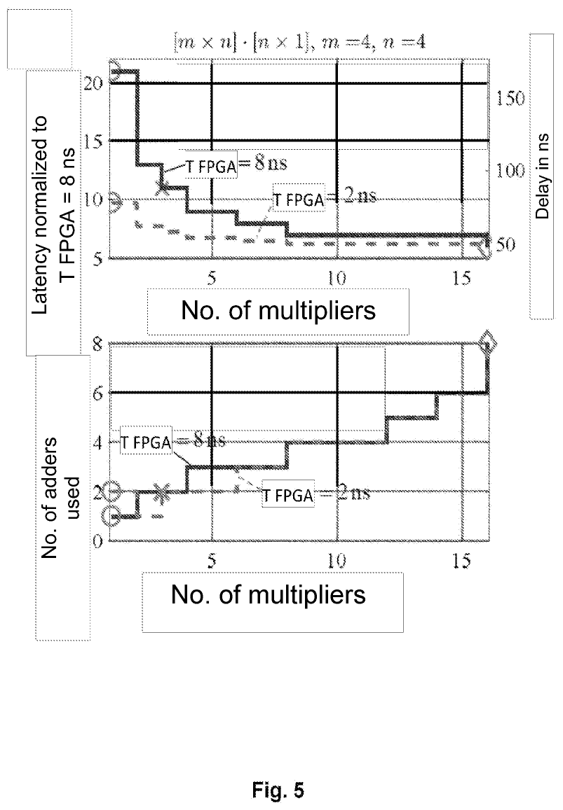

In the two sub-figures of FIG. 5, the lower shows the latency that the matrix-vector multiplication has at a particular number of multipliers Mu1, Mu2, Mu3 and adders Add1. Add2. By comparison with a fully parallelized system having 16 multipliers and 8 adders, the overall latency is increased by just one clock cycle T FPGA when an arrangement configured partly with a time-division multiplexing function having 8 multipliers and 4 adders is implemented. However, this arrangement uses only half the hardware resources needed for a fully parallelized configuration. By taking the latency into account, the matrix-vector multiplication can be designed systematically. In addition, the dashed line shows the influence of the clock cycle T FPGA. In the present case, the clock cycle T FPGA has been reduced to 2 ns whereas the latency for the multiplication and addition has been raised to 8, so a single multiplication or addition takes 16 ns. Therefore, a purely parallel calculation requires 48 ns for both clock cycles T FPGA under examination. If, however, the clock cycle T FPGA is reduced, this will increase the throughput if a multiplexing function is used as in the present case. Thus, the resources are reduced further without increasing the latency. However, the tasks of the scheduler S are likewise increased with the degree of multiplexing, and more computing capacity is needed for the scheduler S.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

SIM Simulator
DUT Device under test
FPGA Arithmetic unit
S Scheduler
mP Microprocessor
IO Input/output interface
M Matrix
M11, M12, . . . , M21, . . . , Mmn Matrix coefficient
V Input vector
v1, v2, . . . , vn Vector component
b Output vector
30 Routing of the coefficients and components
31 Multiplier stage
32 Routing
33 Adder stage
34 Output
Mu1, Mu2, Mu3 Multiplier
Add1, Add2 Adder
T FPGA FPGA clock cycle

1: A simulator, comprising:
an arithmetic unit configured to simulate a technical system;
wherein the simulator is configured to determine an output vector for outputting an output signal of the simulator on the basis of an input vector using matrix-vector multiplication, wherein a matrix represents the technical system;
wherein the arithmetic unit has at least one multiplier and at least one adder for the matrix-vector multiplication, wherein the at least one multiplier and the at least one adder are each configured for a time-division multiplexing function for performing their respective tasks;
wherein a scheduler is provided, which is configured to assign an output value of the at least one multiplier to the at least one adder.

2: The simulator according to claim 1, wherein the technical system is a power electronics circuit having at least one switch, and the matrix represents the power electronics circuit.

3: The simulator according to claim 1, wherein, to implement the time-division multiplexing function, the at least one multiplier and the at least one adder are configured to start their next task before the current task, together with a particular result of the current task, is finished.

4: The simulator according to claim 3, wherein at least two clock cycles are provided for the performance of each task, wherein it is provided that a relevant next task starts in each case once one clock cycle has elapsed.

5: The simulator according to claim 1, wherein the arithmetic unit has a processor and/or a field programmable gate array (FPGA).

6: The simulator according to claim 1, wherein the input vector has electrical parameters which are applicable to the technical system.

7: The simulator according to claim 1, wherein the scheduler is configured to assign matrix coefficients and vector components for the matrix-vector multiplication.

8: The simulator according to claim 7, wherein the scheduler is configured to assign a particular result of each task of at least one particular multiplier to at least one particular adder for the performance of a further task.

9: The simulator according to claim 1, wherein the arithmetic unit has a number of multipliers that is dependent on the size of the matrix.

10: The simulator according to claim 1, wherein the simulator is configured to review the matrix before the matrix-vector multiplication, wherein the carrying out of the task of the at least one multiplier and/or the carrying out of the task of the at least one adder and/or the assignment of the output value by the scheduler is dependent on the result of the review.

11: A method for operating a simulator comprising an arithmetic unit which simulates a technical system comprising a power electronics circuit having at least one switch, wherein the method comprises:
determining, by the simulator, an output vector for outputting an output signal of the simulator on the basis of an input vector using matrix-vector multiplication, wherein the matrix represents the power electronics circuit, wherein the arithmetic unit uses at least one multiplier and at least one adder for the matrix-vector multiplication, wherein the at least one multiplier and the at least one adder each use a time-division multiplexing function for performing their respective tasks; and
assigning, by a scheduler, an output value of the at least one multiplier to the at least one adder.
